(19) United States
(12) Patent Application Publication
(10) Pub. No.: US 2017/0371235 A1
(43) Pub. Date: Dec. 28, 2017

(54) VEHICLE ILLUMINATION DEVICE

(71) Applicant: KABUSHIKI KAISHA TOKAI-RIKA-DENKI-SEISAKUSHO, Aichi (JP)

(72) Inventors: Kazuyuki YOKOYAMA, Aichi (JP); Masatsugu OHASHI, Aichi (JP); Masahiro ARAI, Aichi (JP)

(21) Appl. No.: 15/543,461

(22) PCT Filed: Dec. 17, 2015
(86) PCT No.: PCT/JP2015/085402

§ 371 Date: Jul. 13, 2017

(30) Foreign Application Priority Data
Jan. 20, 2015 (JP) 2015-008819

(51) Int. Cl. G03B 21/20; B60Q 1/26; B60R 1/12; B60R 1/06

(52) U.S. Cl. CPC G03B 21/2046; B60Q 1/2665; B60Q 2400/50; B60R 1/1207; B60R 1/06

(57) ABSTRACT

A projection mechanism of a vehicle projection device projects a graphic of a graphic film toward an outer side of a vehicle. A projection direction of the graphic from the projection mechanism is inclined with respect to a rotation axis of the projection mechanism. Thus, by manually rotating a dial to rotate the projection mechanism about the rotation axis, the projection direction of the graphic from the projection mechanism can be altered, and the projection position of the graphic from the projection mechanism can be altered.

### TECHNICAL FIELD

The present invention relates to a vehicle illumination device that emits light.

### BACKGROUND ART

The specification of Chinese Utility Model Application No. 202382141 describes a graphic projection lamp in which an LED light source and a lens emit light to project an image from a graphic film.

In such a graphic projection lamp, it is preferable for a projection position of the image to be alterable, and moreover, it is preferable for the orientation of the projected image to be alterable.

### SUMMARY OF INVENTION

### Technical Problem

In consideration of the above circumstances, an object of the present invention is to obtain a vehicle illumination device capable of altering a light illumination position, and a vehicle illumination device capable of altering the orientation of a projected image.

### Solution to Problem

A vehicle illumination device of a first aspect of the present invention includes an illumination mechanism and a rotation means. The illumination mechanism is provided at a vehicle and is configured to emit light toward an outer side of the vehicle. The rotation means is operable to rotate the illumination mechanism, and is configured such that an illumination direction of light from the illumination mechanism is inclined with respect to a rotation axis of the illumination mechanism.

A vehicle illumination device of a second aspect of the present invention includes an illumination mechanism, an image member, and a rotation means. The illumination mechanism is provided at a vehicle and is configured to emit light. An image is provided at the image member, the image being projected toward an outer side of the vehicle by emission of light by the illumination mechanism. The rotation means is operable to rotate the image member.

A vehicle illumination device of a third aspect of the present invention is the vehicle illumination device of the first aspect or the second aspect of the present invention, wherein the rotation means is configured to be operated manually.

### Advantageous Effects of Invention

In the vehicle illumination device of the first aspect of the present invention, the illumination mechanism provided at the vehicle is configured to emit light toward the outer side of the vehicle. The rotation means is operable to rotate the illumination mechanism.

The illumination direction of light from the illumination mechanism is inclined with respect to the rotation axis of the illumination mechanism. Thus, by rotating the illumination mechanism, the illumination direction of light from the illumination mechanism is altered, enabling the illumination position of light from the illumination mechanism to be altered.

In the vehicle illumination device of the second aspect of the present invention, the illumination mechanism provided at the vehicle emits light to project the image provided at the image member toward the outer side of the vehicle.

The rotation means is operable to rotate the image member. This enables the orientation of the image projected toward the outer side of the vehicle to be altered.

In the vehicle illumination device of the third aspect of the present invention, the rotation means is configured to be operated manually. This enables a simple configuration.

### BRIEF DESCRIPTION OF DRAWINGS

FIG. 1 is a face-on view illustrating a vehicle door mirror device of a first exemplary embodiment of the present invention, as viewed from the vehicle rear.

FIG. 2 is a face-on view illustrating a vehicle projection device according to the first exemplary embodiment of the present invention, as viewed from the vehicle rear.

FIG. 3 is a plan view illustrating the vehicle projection device according to the first exemplary embodiment of the present invention, as viewed from above.

FIG. 4 is a perspective view illustrating the vehicle projection device according to the first exemplary embodiment of the present invention, as viewed diagonally from the rear right of the vehicle.

FIG. 5 is a cross-section (cross-section taken along line 5-5 in FIG. 3) illustrating the vehicle projection device according to the first exemplary embodiment of the present invention, as viewed from the vehicle rear.

FIG. 6 is a perspective view illustrating relevant portions of the vehicle projection device according to the first exemplary embodiment of the present invention, as viewed diagonally from the rear right of the vehicle.

FIG. 7 is a cross-section (cross-section taken at the position of line 5-5 in FIG. 3) illustrating a vehicle projection device according to a second exemplary embodiment of the present invention, as viewed from the vehicle rear.

FIG. 8 is a cross-section (cross-section taken at the position of line 5-5 in FIG. 3) illustrating a vehicle projection device according to a third exemplary embodiment of the present invention, as viewed from the vehicle rear.

FIG. 9 is a perspective view illustrating the interior of the vehicle projection device according to the third exemplary embodiment of the present invention, as viewed diagonally from the rear right of the vehicle.

FIG. 10 is a perspective view illustrating relevant portions of the vehicle projection device according to the third exemplary embodiment of the present invention, as viewed diagonally from the rear right of the vehicle.

### DESCRIPTION OF EMBODIMENTS

### First Exemplary Embodiment

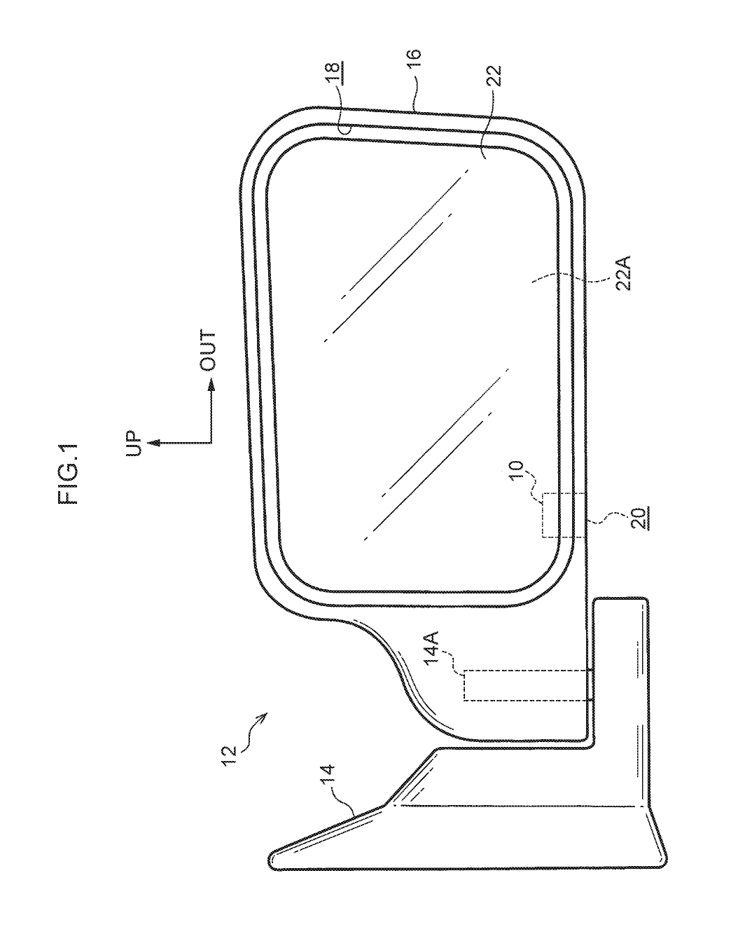

FIG. 1 is a face-on view illustrating a vehicle door mirror device 12 serving as an installation body installed with a vehicle projection device 10, serving as a vehicle illumination device according to a first exemplary embodiment of the present invention, as viewed from the vehicle rear. Note that in the drawings, the arrow FR indicates the vehicle front, the arrow OUT indicates the vehicle width direction outside (vehicle right), and the arrow UP indicates upwards.

The vehicle door mirror device 12 of the present exemplary embodiment is provided at a vehicle outside of an up-down direction intermediate portion and vehicle front side end of a side door (specifically, a front side door), serving as a vehicle door.

As illustrated in FIG. 1, the vehicle door mirror device 12 includes a stay 14, serving as a fixing member. A vehicle width direction inside end of the stay 14 is fixed to the side door (vehicle body side), thereby fixing the vehicle door mirror device 12 to the side door. A support shaft 14A is provided at a vehicle width direction outside portion of the stay 14, and the axial direction of the support shaft 14A is disposed parallel to the up-down direction.

A substantially rectangular container-shaped visor 16, serving as an installation member, is supported by the support shaft 14A. The visor 16 is disposed at the vehicle width direction outside of the stay 14. The visor 16 can pivot in the vehicle front-rear direction about the support shaft 14A, and a pivot position of the visor 16 is adjustable. A substantially rectangular shaped opening 18 is formed penetrating a vehicle rear-side wall of the visor 16, and the opening 18 is open toward the vehicle rear side at the inside of the visor 16. A substantially rectangular shaped through hole 20 is formed penetrating a lower wall of the visor 16, and the through hole 20 is open toward the lower side at the inside of the visor 16.

An attachment mechanism (not illustrated in the drawings) is fixed to the inside of the visor 16, and a substantially rectangular plate shaped mirror 22, serving as a visual recognition means, is attached to the attachment mechanism. The mirror 22 is disposed inside the visor 16 in the vicinity of the opening 18. The mirror 22 substantially closes off the opening 18. A mirror surface 22A of the mirror 22 faces toward the vehicle rear side, such that the mirror 22 enables visual recognition rearward of the vehicle by an occupant of the vehicle (in particular, the driver), thus assisting the occupant with visual recognition. Further, the mirror 22 can be detached from the attachment mechanism. When the mirror 22 has been detached from the attachment mechanism, the inside of the visor 16 is open to the vehicle rear side through the opening 18.

The vehicle projection device 10 is housed inside the visor 16, at an upper side of the through hole 20.

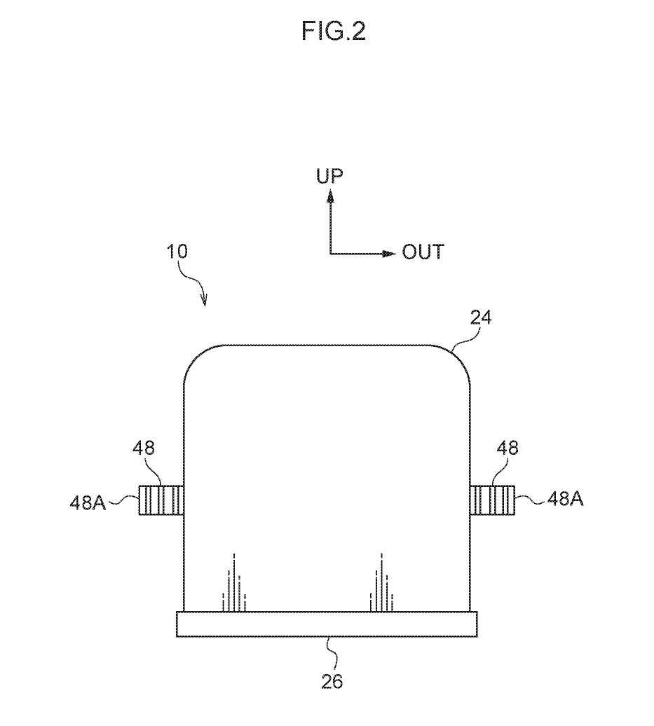

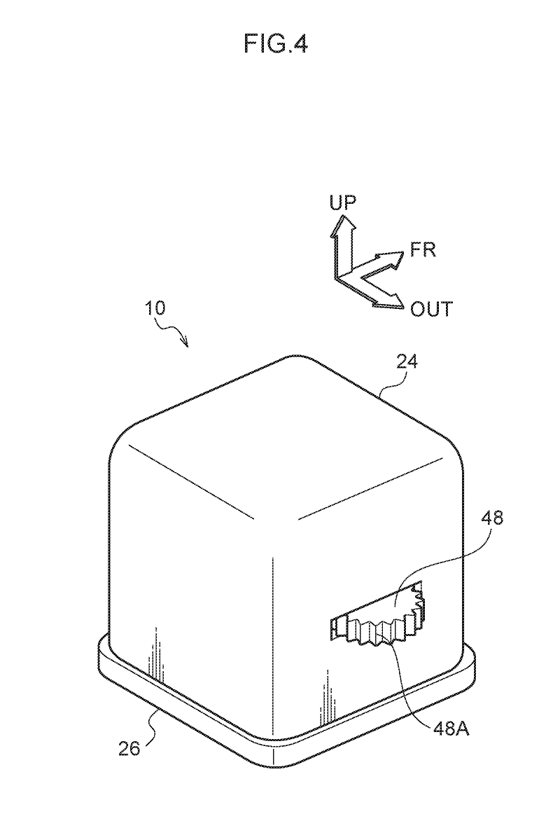

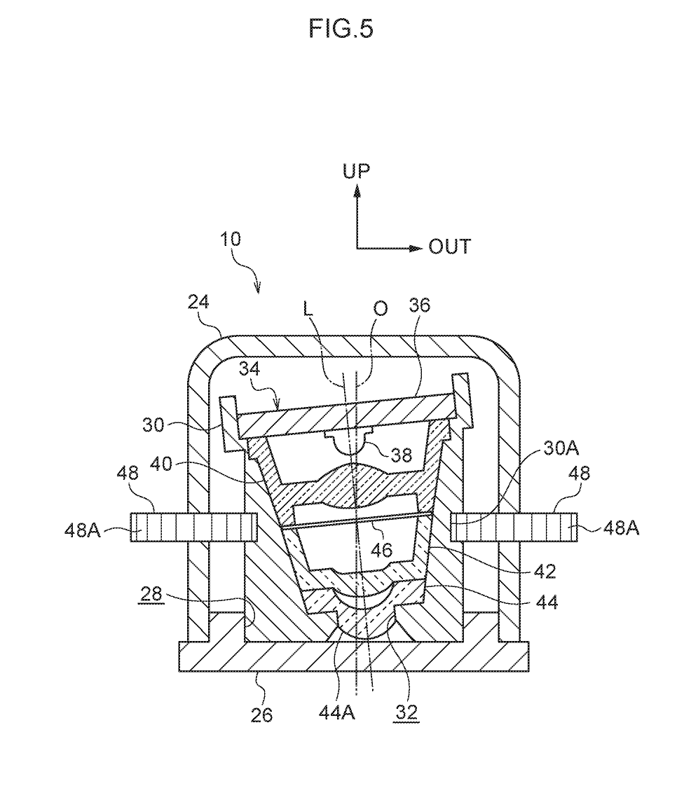

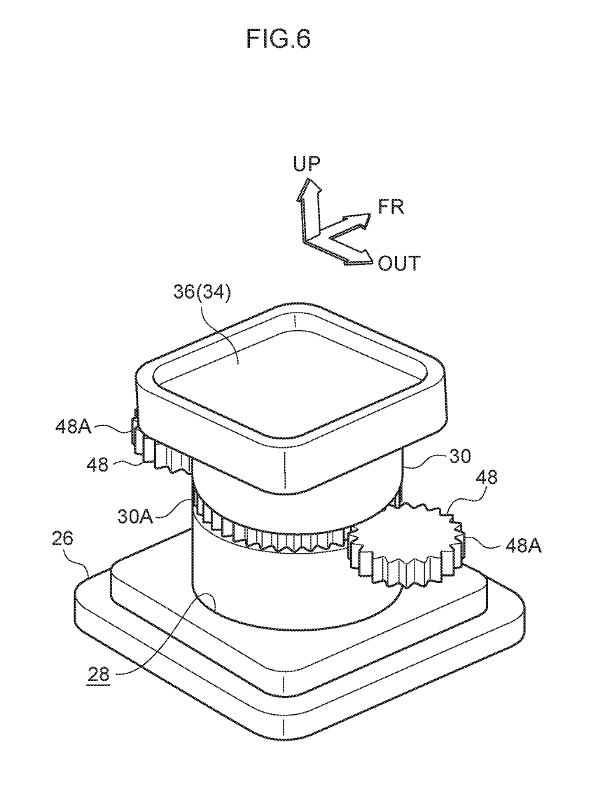

As illustrated in FIG. 2 to FIG. 6, in the vehicle projection device 10, a substantially rectangular container-shaped housing 24 serving as a support body (exterior member) is provided at the vehicle projection device 10, and a lower face of the housing 24 is configured with an opening. The housing 24 is fixed inside the visor 16, thereby installing the vehicle projection device 10 inside the visor 16.

A rectangular plate shaped outer lens 26, serving as an exposure member, is fixed to a lower side of the housing 24, and the outer lens 26 closes off the opening in the lower face of the housing 24. The outer lens 26 is disposed inside the through hole 20 of the visor 16, such that the outer lens 26 closes off the through hole 20. A circular shaped support recess 28 is formed coaxially to an upper face of the outer lens 26, and the support recess 28 is open to the upper side.

A substantially circular columnar box-shaped case 30 serving as a housing body (interior member) is housed inside the housing 24, and light cannot pass through the case 30. A lower end of the case 30 is housed in the support recess 28. The case 30 is rotatably supported by the support recess 28, with a rotation axis O disposed parallel to the up-down direction. A space inside of the case 30 is configured with a substantially inverted circular frustum-shape. An axial center line L inside the case 30 is inclined with respect to (crosses) the rotation axis O of the case 30. A circular shaped exposure hole 32 is formed penetrating a lower wall (bottom wall) of the case 30. The exposure hole 32 is disposed coaxial to the inside of the case 30.

A projection mechanism 34, serving as an illumination mechanism, is provided inside the case 30.

A rectangular plate shaped circuit board 36, serving as a supply body, is provided at the projection mechanism 34, and the circuit board 36 is fixed to an upper end portion inside the case 30 and is electrically connected to a power source (not illustrated in the drawings).

An LED 38, serving as a light source, is fixed to a lower face of the circuit board 36. The LED 38 is electrically connected to the circuit board 36. The LED 38 is housed inside the upper end portion of the case 30, and the LED 38 is disposed on the axial center line L of the case 30.

Inside the case 30, a collimator lens 40 that has a substantially H-shaped cross-section profile and that serves as a first lens is housed coaxially to and at a lower side of the circuit board 36. The collimator lens 40 is fixed inside the case 30.

Inside the case 30, a first image-forming lens 42 that has a substantially U-shaped cross-section profile and that serves as a second lens is housed coaxially to and at a lower side of the collimator lens 40. The first image-forming lens 42 is fixed inside the case 30.

Inside the case 30, a second image-forming lens 44 that has a substantially T-shaped cross-section profile and that serves as a third lens is housed coaxially to and at a lower side of the first image-forming lens 42. The second image-forming lens 44 is fixed inside the case 30. A protrusion portion 44A that has a substantially circular columnar shape is coaxially formed to the second image-forming lens 44. The protrusion portion 44A protrudes out toward the lower side and is fitted into the exposure hole 32 of the case 30.

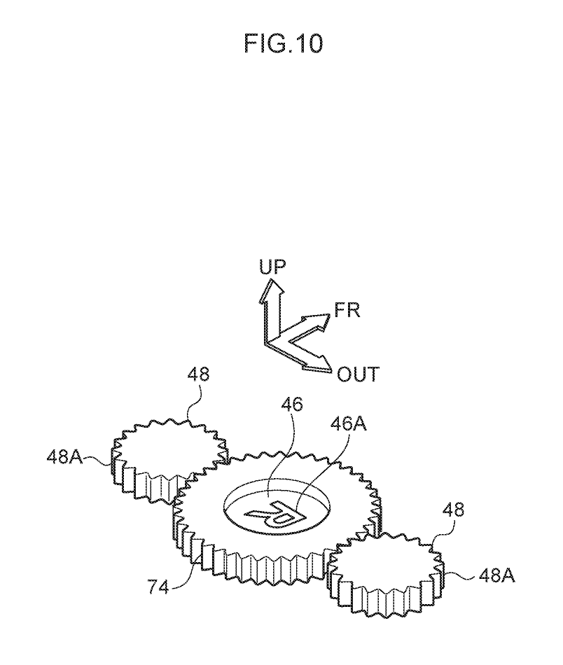

Inside the case 30, a graphic film 46 in the shape of a circular sheet and serving as an image member is housed between the collimator lens 40 and the first image-forming lens 42. The graphic film 46 is fixed inside the case 30. A graphic 46A, such as a symbol (see FIG. 10), that serves as an image is provided at a central-side portion of the graphic film 46. Light is capable of passing through the graphic film 46.

A rotation gear 30A is formed around an up-down direction intermediate portion of an outer peripheral face of the case 30, and the rotation gear 30A is disposed coaxially to the rotation axis O of the case 30.

Dials 48 each having a substantially circular disk shape and serving as a rotation means (manual operation member) are disposed on the vehicle right side and the vehicle left side of the rotation gear 30A. Each dial 48 penetrates through a side wall of the housing 24 and is rotatably supported by the housing 24. A manual operation gear 48A is formed around the outer periphery of each dial 48, and the manual operation gears 48A are meshed together with the rotation gear 30A.

Explanation follows regarding operation of the present exemplary embodiment.

In the vehicle projection device 10 of the vehicle door mirror device 12 configured as described above, electric power from the power source is supplied to the LED 38 through the circuit board 36, and the LED 38 radiates light toward the lower side such that the light passes through (travels through) the collimator lens 40, the graphic film 46, the first image-forming lens 42, the second image-forming lens 44 (the exposure hole 32 in the case 30), and the outer lens 26 (the through hole 20 in the visor 16). The graphic 46A of the graphic film 46 is projected (beamed) onto the ground at the outer side of the vehicle (the light is emitted onto the ground at the outer side of the vehicle).

The projection direction of the graphic 46A (an optical axis of the projection mechanism 34, the axial center line L inside the case 30, and the light illumination direction (an axial center line of an emitted area)) from the projection mechanism 34 of the case 30 is inclined with respect to the rotation axis O of the case 30 (axial center line of the rotation gear 30A).

Further, when the mirror 22 has been detached from the attachment mechanism on the inside of the visor 16 and the inside of the visor 16 is open to the vehicle rear side through the opening 18, the dials 48 of the vehicle projection device 10 are exposed to the vehicle rear side through the opening 18.

Accordingly, by manually rotating the dials 48 (manual operation gears 48A), the case 30 (rotation gear 30A) is rotated to rotate the projection mechanism 34 about the rotation axis O. This enables the projection direction of the graphic 46A from the projection mechanism 34 to be altered, and enables the peripheral direction position of the graphic film 46 to be altered. This enables the projection position (light illumination position) of the graphic 46A from the projection mechanism 34 to be altered, thereby enabling the orientation of the graphic 46A projected onto the ground at the outer side of the vehicle to be altered even in cases in which, for example, the pivot position of the visor 16 has been altered.

Moreover, the projection direction of the graphic 46A from the projection mechanism 34 can be altered without swinging the case 30. This enables the need to provide a space in which to swing the case 30 to be eliminated, enabling space to be saved.

Further, as described above, by manually rotating the dials 48, the case 30 is rotated such that the projection direction of the graphic 46A from the projection mechanism 34 and the peripheral direction position of the graphic film 46 are altered. This enables the projection direction of the graphic 46A from the projection mechanism 34 and the peripheral direction position of the graphic film 46 to be altered using a simple configuration.

Note that in the present exemplary embodiment, the graphic film 46 is provided inside the case 30. However, the graphic film 46 need not be provided inside the case 30.

### Second Exemplary Embodiment

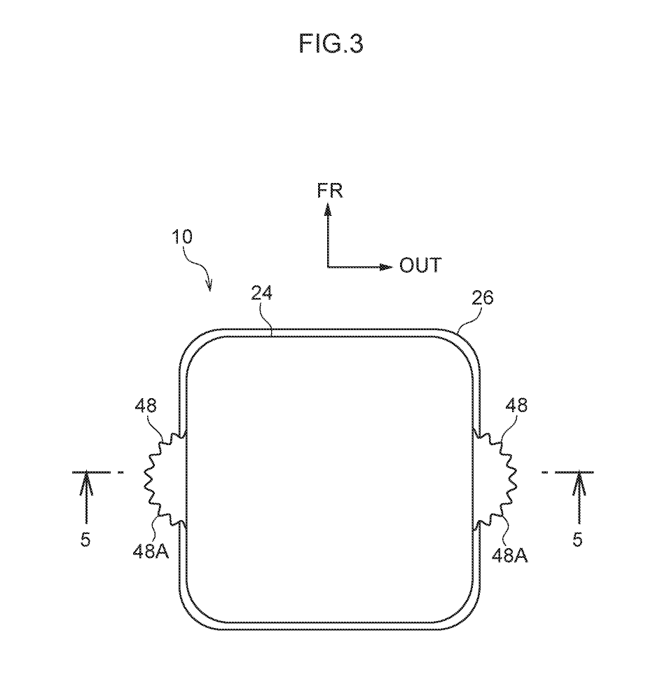

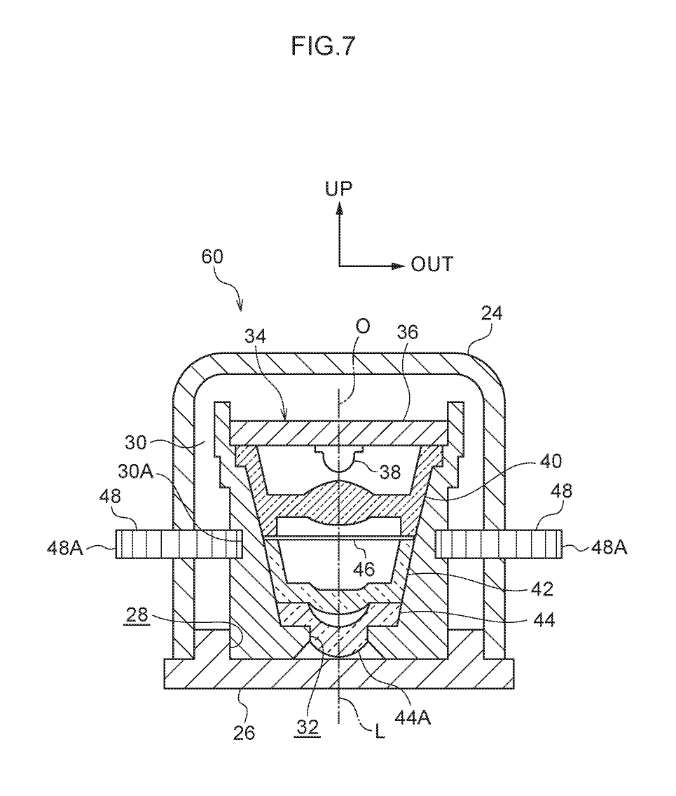

FIG. 7 illustrates a cross-section (cross-section taken at the position of line 5-5 in FIG. 3) of a vehicle projection device 60 serving as a vehicle illumination device according to a second exemplary embodiment of the present invention, as viewed from the vehicle rear.

The vehicle projection device 60 according to the present exemplary embodiment has substantially the same configuration as that of the first exemplary embodiment described above but differs in the following points.

As illustrated in FIG. 7, in the vehicle projection device 60 according to the present exemplary embodiment, the axial center line L inside the case 30 is aligned (is configured parallel) with the rotation axis O of the case 30, and the projection direction of the graphic 46A from the projection mechanism 34 of the case 30 is configured so as to be aligned (to be parallel) with the rotation axis O of the case 30.

Similarly to the first exemplary embodiment described above, when the mirror 22 has been detached from the attachment mechanism inside the visor 16 and the interior of the visor 16 is open to the vehicle rear side through the opening 18, the dials 48 of the vehicle projection device 60 are exposed to the vehicle rear side through the opening 18.

Accordingly, by manually rotating the dials 48 (manual operation gears 48A), the case 30 (rotation gear 30A) is rotated to rotate the projection mechanism 34 about the rotation axis O. This enables the peripheral direction position of the graphic film 46 to be altered, thereby enabling the orientation of the graphic 46A projected onto the ground at the outer side of the vehicle to be altered even in cases in which, for example, the rotation position of the visor 16 has been altered.

As described above, by manually rotating the dials 48, the case 30 is rotated such that the peripheral direction position of the graphic film 46 is altered. This enables the peripheral direction position of the graphic film 46 to be altered with a simple configuration.

### Third Exemplary Embodiment

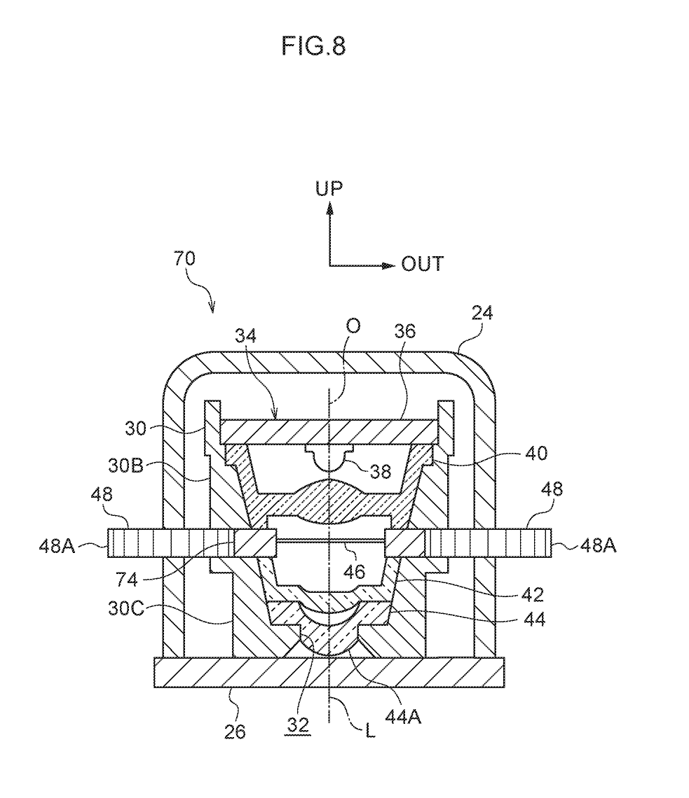

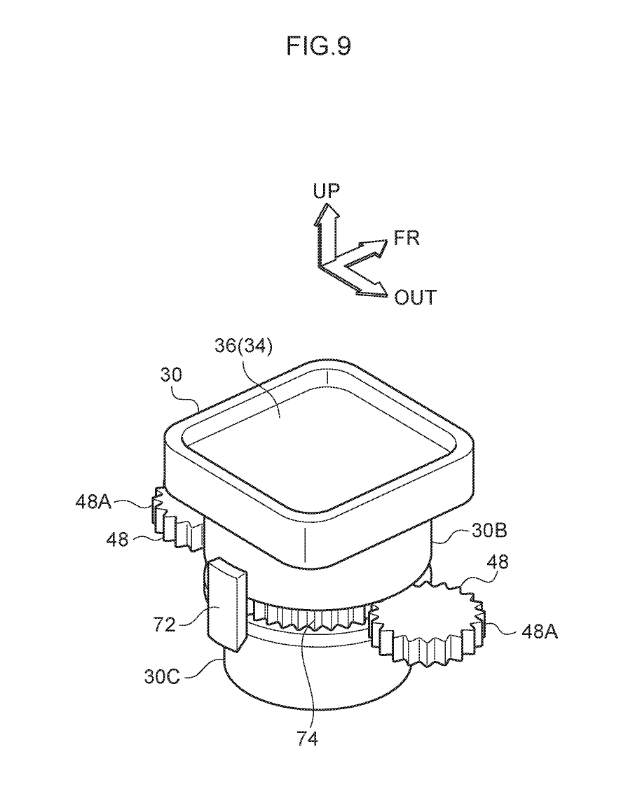

FIG. 8 illustrates a cross-section (cross-section taken at the position of line 5-5 in FIG. 3) of a vehicle projection device 70 serving as a vehicle illumination device according to a third exemplary embodiment of the present invention, as viewed from the vehicle rear. FIG. 9 illustrates a perspective view of the interior of the vehicle projection device 70, as viewed diagonally from the rear right of the vehicle.

The vehicle projection device 70 according to the present exemplary embodiment has substantially the same configuration as that of the second exemplary embodiment described above but differs in the following points.

As illustrated in FIG. 8 and FIG. 9, in the vehicle projection device 70 according to the present exemplary embodiment, the case 30 is fixed inside the housing 24. The case 30 is divided into an upper case 30B at an upper side of the graphic film 46, and a lower case 30C at a lower side of the graphic film 46. An outer peripheral face of the upper case 30B and an outer peripheral face of the lower case 30C are disposed coaxially to each other and are coupled together by a predetermined number (two in the present exemplary embodiment) of coupling plates 72.

An outer periphery of the graphic film 46 is coaxially fixed to a circular ring shaped rotation gear 74 (see FIG. 10). The rotation gear 74 is supported between the upper case 30B and the lower case 30C so as to be coaxially rotatable therebetween, and the rotation gear 74 is meshed together with the manual operation gears 48A of the dials 48.

Similarly to in the first exemplary embodiment described above, when the mirror 22 has been detached from the attachment mechanism inside the visor 16 and the inside of the visor 16 is open to the vehicle rear side through the opening 18, the dials 48 of the vehicle projection device 70 are exposed to the vehicle rear side through the opening 18.

Thus, the dials 48 (manual operation gears 48A) are manually rotated to rotate the rotation gear 74, such that the graphic film 46 is rotated about an axial center line. This enables the peripheral direction position of the graphic film 46 to be altered, thereby enabling the orientation of the graphic 46A projected onto the ground at the outer side of the vehicle to be altered even in cases in which, for example, the pivot position of the visor 16 has been altered.

As described above, by manually rotating the dials 48, the rotation gear 74 is rotated such that the peripheral direction position of the graphic film 46 is altered. This enables the peripheral direction position of the graphic film 46 to be altered with a simple configuration.

Note that in the first exemplary embodiment to the third exemplary embodiment described above, plural of the dials 48 (manual operation gears 48A) are provided. However, a single dial 48 (manual operation gear 48A) may be provided.

Moreover, in the first exemplary embodiment to the third exemplary embodiment described above, the dials 48 (manual operation gears 48A) are meshed together with the rotation gear 30A, 74. However, the dials 48 (manual operation gears 48A) may be configured so as to mesh together (coupled) with the rotation gear 30A, 74 through a predetermined number of intermediate gears.

In the first exemplary embodiment to the third exemplary embodiment described above, the dials 48 are manually rotated, causing the case 30 or the graphic film 46 to rotate. However, the case 30 or the graphic film 46 may be rotated electrically (such as by a motor). Further, the case 30 or the graphic film 46 may be rotated in conjunction with swinging (such as stowing) operation of the visor 16 (including the mirror 22).

Moreover, in the first exemplary embodiment to the third exemplary embodiment described above, the vehicle projection device 10, 60, 70 is installed in the vehicle door mirror device 12. However, it is sufficient that the vehicle projection device 10, 60, 70 be capable of projecting the graphic 46A toward the outer side of the vehicle (be capable of emitting light toward the outer side of the vehicle). For example, the vehicle projection device 10, 60, 70 may be installed to a door (including a door handle) of the vehicle. The vehicle projection device 10, 60, 70 may even be installed to a location on the vehicle cabin side of a door, as long as the vehicle projection device 10, 60, 70 is capable of projecting the graphic 46A toward the outer side of the vehicle when the door has been opened.

The disclosure of Japanese Patent Application No. 2015-8819, filed on Jan. 20, 2015, is incorporated in its entirety by reference herein.

### EXPLANATION OF THE REFERENCE NUMERALS

10 vehicle projection device (vehicle illumination device)
34 projection mechanism (illumination mechanism)
46 graphic film (image member)
46A graphic (image)
48 dial (rotation means)
60 vehicle projection device (vehicle illumination device)
70 vehicle projection device (vehicle illumination device)

1-5. (canceled)

6. A vehicle illumination device, comprising:
an illumination mechanism that is provided at a vehicle and that is configured to emit light toward an outer side of the vehicle;
a rotation means that is operable to rotate the illumination mechanism, and that is configured such that an illumination direction of light from the illumination mechanism is inclined with respect to a rotation axis of the illumination mechanism; and
a rotation body that is provided with the illumination mechanism, that is configured to be rotated about an axis of the rotation body such that the illumination mechanism is rotated, and that is configured such that the illumination direction of light from the illumination mechanism is inclined with respect to an axial direction of the rotation body.

7. The vehicle illumination device of claim 6, wherein the rotation means is configured to be operated manually.

8. The vehicle illumination device of claim 6, wherein the rotation means is configured to be operated electrically.

9. The vehicle illumination device of claim 6, wherein the rotation means is configured to be operated in conjunction with operation of an installation body that is installed with the vehicle illumination device.
